(19) United States
(12) Patent Application Publication
(10) Pub. No.: US 2023/0411611 A1
(43) Pub. Date: Dec. 21, 2023

(54) POSITIVE ELECTRODE MATERIAL FOR LIHITUM SECONDARY BATTERY AND LITHIUM SECONDARY BATTERY INCLUDING THE SAME

(71) Applicants: Hyundai Motor Company, Seoul (KR); Kia Corporation, Seoul (KR)

(72) Inventors: Sang Ha Lee, Suwon (KR); Ki Jung Kim, Yongin (KR); Hye Rim Oh, Uiwang (KR)

(21) Appl. No.: 17/986,493

(22) Filed: Nov. 14, 2022

(30) Foreign Application Priority Data
Jun. 21, 2022 (KR) 10-2022-0075729

(51) Int. Cl. H01M 4/485; H01M 4/62; H01M 4/505; H01M 4/525; H01M 4/04; H01M 10/0525

(52) U.S. Cl. CPC H01M 4/485; H01M 4/625; H01M 4/623; H01M 4/505; H01M 4/525; H01M 4/0404; H01M 10/0525; H01M 2004/028

(57) ABSTRACT

Provided is a positive electrode material for a lithium secondary battery and the lithium secondary battery including the positive electrode material. The positive electrode material includes an open circuit voltage (OCV) modifier for changing an OCV to predict accurate state of charge (SOC) and state of health (SOH). A positive electrode material for a lithium (Li) secondary battery, which forms a positive electrode of the Li secondary battery, includes a main positive electrode material including a positive electrode active material formed of a lithium ferrum phosphoric acid (LFP) oxide, a conductive material, and a binder and an OCV modifier transforming the OCV.

### CROSS REFERENCE TO RELATED APPLICATION

The present application claims priority to Korean Patent Application No. 10-2022-0075729, filed on Jun. 21, 2022, the entire contents of which is incorporated herein for all purposes by this reference.

### TECHNICAL FIELD

The present disclosure relates to a positive electrode material for a lithium secondary battery and the lithium secondary battery including the positive electrode material. The positive electrode material may include an open circuit voltage (OCV) modifier for changing an OCV to predict accurate state of charge (SOC) and state of health (SOH).

### BACKGROUND

Secondary batteries have been used as high-performance energy sources for electric vehicles, large-capacity power storage batteries, portable electronic devices, etc. Recently, for miniaturization of portable electronic devices and continuous use thereof for a long time, there is a need for a secondary battery capable of realizing small size and high capacity along with research on weight reduction and low power consumption of parts.

In particular, a lithium secondary battery that is a representative secondary battery has higher energy density, larger capacity per area, lower self-discharge rate, and longer lifetime than a nickel manganese battery or a nickel cadmium battery. Because of no memory effect, characteristics of convenience in use and long lifetime may be provided.

For a lithium secondary battery, electric energy is produced by oxidation and reduction reactions when lithium ions are intercalated/deintercalated in a positive electrode and a negative electrode in a state where an electrolyte is charged between the positive electrode and the negative electrode that are composed of active materials into and from which the lithium ions may be intercalated and deintercalated.

FIG. 1 shows a general lithium secondary battery, and FIG. 2 shows a positive electrode of a general lithium secondary battery.

As shown in FIG. 1, the general lithium secondary battery includes a positive electrode 10, an electrolyte 40, a separation film 30, and a negative electrode 20.

The positive electrode 10 is manufactured by coating a positive electrode material 12 onto a positive electrode current collector 11 made of an aluminum material, and the negative electrode 20 is manufactured by coating a negative electrode material 22 onto the negative electrode current collector 21 made of a copper material. For example, the positive electrode material 12 may include a positive electrode active material 13, a conductive material 14, and a binder 15, and the negative electrode material 22 may include a negative electrode active material, a conductive material, and a binder. Meanwhile, a lithium secondary battery is classified as a ternary secondary battery or a lithium ferrum phosphoric acid (LFP) secondary battery, according to a positive electrode active material used other than lithium.

The ternary secondary battery is a secondary battery using three types of active materials as a positive electrode material based on lithium (Li), and representatively uses a nickel-cobalt-manganese (NCM)-based active material or a nickel-cobalt-aluminum (NCA)-based active material.

The LFP secondary battery is based on Li, but uses iron (Fe) instead of cobalt (Co). Such an LFP secondary battery uses Fe instead of rare metals such as Co and Ni, thereby lowering the production cost of secondary batteries in comparison to ternary secondary batteries. Moreover, the LFP secondary battery is easy to use and has a low risk of explosion in case of fire, due to a smaller amount of heat emission than the ternary secondary battery.

Meanwhile, in general, a state of charge (SOC) of a secondary battery may be predicted and calculated by measuring an open circuit voltage (OCV).

Generally, an LFP secondary battery is characterized by a flat SOC-OCV. Thus, due to a small change of an OCV with respect to a change of an SOC, the SOC of the LFP secondary battery is not easy to accurately predict, and in spite of prediction, an error rate is high (≥3%).

Meanwhile, devices in other fields to which an LFP secondary battery is applied use a complex evaluation method of adopting a current integration method as a base evaluation method to measure the SOC of the LFP secondary battery and then performing recalibration by measuring an OCV in a high-SOC region or a low-SOC region where the SOC-OCV is not relatively flat.

However, due to characteristics of a vehicle that does not use a high-SOC region or a low-SOC region for durability, it may be difficult to apply the complex evaluation method. Thus, the present applicant has seen that by adding a material capable of changing an OCV to a positive electrode material of an LFP secondary battery, the degree of change of the OCV with the change of the SOC of the Li secondary battery may be relatively accurately predicted, and has completed the present disclosure.

The matters described as the background art are merely for understanding the background of the present disclosure, and should not be accepted as acknowledging that they correspond to the prior art known to those of ordinary skill in the art.

### SUMMARY

In preferred aspects, provided is a positive electrode material for a lithium secondary battery and the lithium secondary battery including the positive electrode material. In particular, the positive electrode material may include an open circuit voltage (OCV) modifier for changing an OCV to predict accurate state of charge (SOC) and state of health (SOH).

Technical problems to be solved in the present disclosure are not limited to the above-mentioned technical problems, and other unmentioned technical problems may be clearly understood by those skilled in the art from the description of the present disclosure.

In an aspect, provided is a positive electrode material for a lithium (Li) secondary battery, which forms a positive electrode of the Li secondary battery, includes (i) a main positive electrode material including a positive electrode active material including a lithium ferrum phosphoric acid (LFP) oxide, a conductive material, and a binder and (ii) an OCV modifier transforming the OCV.

The positive electrode active material may suitably include the OCV modifier in an amount of about 3 to 12 parts by weight with respect to 100 parts by weight of the main positive electrode material.

The positive electrode active material may suitably include the OCV modifier in an amount of about 5 to 10 parts by weight with respect to 100 parts by weight of the main positive electrode material.

The positive electrode active material may include LiFePO₄, the conductive material may include carbon black, and the binder may include polyvinylidene fluoride (PVDF). The main positive electrode material may include the positive electrode active material in amount of about 88 to 98 wt %, the conductive material in amount of about 0.5 to 10 wt %, and the binder in amount of about 0.5 to 5 wt % based on the total weight of the main positive electrode material.

The OCV modifier may include one or more of a ternary active material, an extended material of a ternary active material, an LMO-based active material, a metal that reacts with Li in a potential region of about 2.5 to 3.5 V vs. Li/Li⁺, and a metal oxide reacting with Li in a potential region of about 2.5 to 3.5 V vs. Li/Li⁺.

The ternary active material may include a nickel-cobalt-manganese (NCM)-based active material or a nickel-cobalt-aluminum (NCA)-based active material. The extended material of the ternary active material may include a nickel-cobalt-manganese-aluminum (NCMA)-based active material. The metal reacting with lithium (Li) in the potential region of about 2.5 to 3.5 V vs. Li/Li⁺ may include ruthenium (Ru) or iridium (Ir). The metal oxide reacting with lithium (Li) in the potential region of about 2.5 to 3.5 V vs. Li/Li⁺ may include a manganese oxide, a nickel oxide, a cobalt oxide, a sulfur oxide, a ruthenium oxide or an iridium oxide.

In an aspect, provided is a lithium secondary battery including: a positive electrode where a positive electrode material is coated onto a positive electrode current collector, the positive electrode including a main positive electrode material including a positive electrode active material formed of an LFP oxide and an OCV modifier transforming the OCV; a negative electrode including a negative electrode active material coated onto a negative electrode current collector; and an electrolyte.

The main positive electrode material may further include a conductive material and a binder, and the main positive electrode material may include the positive electrode active material in an amount of about 88 to 98 wt %, the conductive material in an amount of about 0.5 to 10 wt %, and the binder in an amount of about 0.5 to 5 wt %, based on the total weight of the main positive electrode material.

The positive electrode active material may include LiFePO4, the conductive material may include carbon black, and the binder may include PVDF.

The positive electrode active material may include the OCV modifier in an amount of about 3 to 12 parts by weight, preferably, an amount of about 5 to 10 parts by weight, with respect to 100 parts by weight of the main positive electrode material.

The OCV modifier may include one or more of a ternary active material, an extended material of a ternary active material, an LMO-based active material, a metal that reacts with Li in the potential region of about 2.5 to 3.5 V vs. Li/Li⁺, and a metal oxide reacting with Li in a potential region of about 2.5 to 3.5 V vs. Li/Li⁺.

The ternary active material may include an NCM-based active material or an NCA-based active material, the extended material of the ternary active material may include an NCMA-based active material, the metal reacting with Li in the potential region of about 2.5 to 3.5 V vs. Li/Li⁺ may include Ru or Ir, and the metal oxide reacting with Li in the potential region of about 2.5 to 3.5 V vs. Li/Li⁺ may include a manganese oxide, a nickel oxide, a cobalt oxide, a sulfur oxide, a ruthenium oxide, or an iridium oxide.

Provided is also a vehicle that includes the lithium secondary battery described herein.

Other aspects are disclosed infra.

According to various exemplary embodiments of the present disclosure, by further adding the OCV modifier capable of changing the OCV to the positive electrode material, the degree of change of the OCV with the change of the SOC of the Li secondary battery may be accurately predicted.

Consequently, the LFP secondary battery may be accurately controlled, and the state of the LFP secondary battery may be accurately determined, thereby improving the lifetime and fire safety of the battery.

### BRIEF DESCRIPTION OF THE DRAWINGS

FIG. 1 shows a general lithium (Li) secondary battery in the related art.

FIG. 2 shows a positive electrode of a general Li secondary battery in the related art.

FIG. 3 shows an exemplary positive electrode of an Li secondary battery according to an exemplary embodiment of the present disclosure.

FIG. 4 shows a state of charge (SOC)-open circuit voltage (OCV) of an Li secondary battery to which a positive electrode is applied, according to a comparative example and an embodiment.

### DETAILED DESCRIPTION

Hereinafter, an embodiment disclosed herein will be described in detail with reference to the accompanying drawings, and regardless of figure symbols, the same component or similar components will be given the same reference numeral and a redundant description will not be provided.

When an embodiment disclosed herein is described, a detailed description of related well-known techniques will be omitted if it obscures the subject matter of the embodiment disclosed herein. In addition, the accompanying drawings are only for easy understanding of the embodiments disclosed in the present specification, and it should be understood that the technical spirit disclosed herein is not limited by the accompanying drawings and all changes, equivalents, and substitutes included in the spirit and scope of the present disclosure are included.

Although ordinal numbers such as “first”, “second”, and so forth will be used to describe various components of the present disclosure, those components are not limited by the terms. These terms may be used for the purpose of distinguishing one component from another component.

Singular forms include plural forms unless apparently indicated otherwise contextually.

It will be further understood that the terms “comprises” and/or “has,” when used in this specification, specify the presence of a stated feature, number, step, operation, component, element, or combination thereof, but do not preclude the presence or addition of one or more other features, numbers, steps, operations, components, elements, or combinations thereof.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

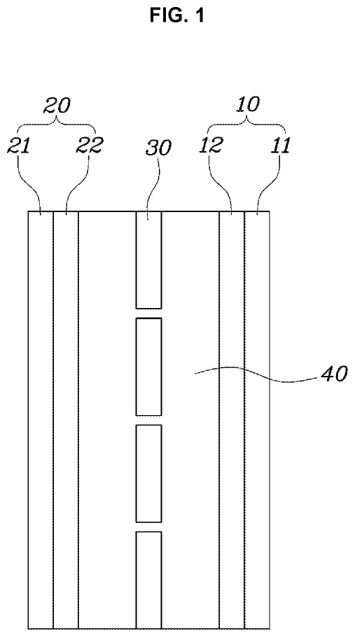

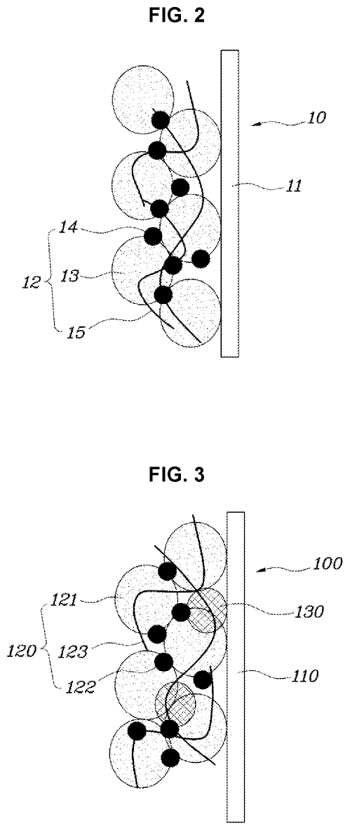

A lithium (Li) secondary battery may include a lithium ferrum phosphoric acid (LFP) secondary battery, and may be formed with the same configuration as the general Li secondary battery shown in FIG. 1.

For example, the Li secondary battery may include a positive electrode, a negative electrode, a separation film, and an electrolyte.

The positive electrode may be formed by coating positive electrode materials 120 and 130 onto a positive electrode current collector.

The positive electrode material may include a main positive electrode material 120 including a positive electrode active material 121 including LFP and an OCV modifier 130 that transforms an OCV.

The positive electrode current collector 110 may transfer current to or from the positive electrode active material 121 during charging or discharging, and may use the positive electrode current collector 110 made of low-resistance metal, e.g., an aluminum material.

The main positive electrode material 120 may further include a conductive material 122 and a binder 123.

The positive electrode active material 121 may include an LFP oxide, for example, LiFePO₄. The conductive material 122 may provide conductivity to the positive electrode, and any electronic conductive material may be used in a configured battery as long as it does not cause a chemical change, and for example, natural graphite, artificial graphite, carbon black, acetylene black, Ketjen black, carbon fiber, metal powder such as copper, nickel, aluminum, silver, etc., metal fiber, or the like may be used, and one type of conductive materials such as polyphenylene derivatives or a combination of one or more types may be used. For example, carbon black may be used as a conductive material.

The binder 123 may attach particles of respective positive electrode active materials well to each other or to a current collector, and for example, polyvinyl alcohol, carboxymethyl cellulose (CMC), hydroxypropyl cellulose, diacetyl cellulose, polyvinyl chloride, carboxylated polyvinyl chloride, polyvinylidene fluoride, polymer containing ethylene oxide, polyvinylpyrrolidone, polyurethane, polytetrafluoroethylene, polyvinylidene fluoride, polyethylene, polypropylene, styrene-butadiene rubber (SBR), acrylated styrene-butadiene rubber, epoxy resin, nylon, etc., may be used, without being limited thereto. For example, in the current embodiment, polyvinylidene fluoride (PVDF) may be used as the binder 123.

The main positive electrode material 120 may preferably include a positive electrode active material in an amount of about 88 to 98 wt %, the conductive material in amount of about 0.5 to 10 wt %, and the binder in an amount of about 0.5 to 5 wt % based on the total weight of the main positive electrode material. The main positive electrode material 120 may preferably include a positive electrode active material in an amount of about 92 to 96 wt %, the conductive material in an amount of about 1.5 to 3.5 wt %, and the binder in an amount of about 2.5 to 4.5 wt % based on the total weight of the main positive electrode material.

Meanwhile, the OCV modifier 130 may be an additive included in a positive electrode material to accurately predict the degree of change of the OCV with the change of the SOC of the Li secondary battery, and may include an amount of about 3 to 12 parts by weight, preferably an amount of about 5 to 10 parts by weight, with respect to 100 parts by weight of the main positive electrode material 120.

When the content of the OCV modifier 130 is less than a predetermined content, e.g., less than about 3 parts by weight, a change of the OCV may be small, such that the effect of improving the accuracy of predicting the SOC of the Li secondary battery is insufficient, and when the content is greater than the predetermined content, e.g., greater than about 12 parts by weight, an added OCV modifier may increase and thus the amount of a positive electrode active material forming a main positive electrode material decreases, such that the advantages of the LFP secondary battery, such as high safety, low production cost, and low heat emission, may be reduced.

Meanwhile, the OCV modifier 130 may use various materials having a greater degree of the change of the OCV with the change of SOC than that of the LFP.

For example, as the OCV modifier 130, at least one of a ternary active material, an extended material of a ternary active material, a lithium manganese oxide (LMO)-based active material, a metal that reacts with Li in a potential region of about 2.5 to 3.5 V vs. Li/Li⁺, may and a metal oxide reacting with Li in a potential region of about 2.5 to 3.5 V vs. Li/Li⁺ may be used.

A nickel-cobalt-manganese (NCM)-based active material or a nickel-cobalt-aluminum (NCA)-based active material may be used as the ternary active material, or a nickel-cobalt-manganese-aluminum (NCMA)-based active material may be used as the extended material of the ternary active material.

Ruthenium (Ru) or iridium (Ir) may be used as the metal reacting with Li in the potential region of about 2.5 to 3.5 V vs. Li/Li⁺, and a manganese oxide, a nickel oxide, a cobalt oxide, a sulfur oxide, a ruthenium oxide or an iridium oxide may be used as the metal oxide reacting with Li in the potential region of about 2.5 to 3.5 V vs. Li/Li⁺.

A negative electrode may be formed by coating a negative electrode material onto a negative electrode current collector.

The negative electrode material may be formed of a negative electrode active material, a conductive material, and a binder.

As the negative electrode active material, natural graphite, artificial graphite, low crystalline carbon and metallic materials such as a silicon oxide and a silicon carbide may preferably be used.

The negative electrode current collector may transfer current to or from the positive electrode active material during charging and discharging, and a negative electrode current collector made of metal having low electric resistance, e.g., a copper material, may be applied.

The separation film prevents short-circuit between a positive electrode and a negative electrode, and provides a moving path of Li ions. As the separation film, a known film like a polyolefin-based polymer film such as polypropylene, polyethylene, polyethylene/polypropylene, polyethylene/polypropylene/polyethylene, polypropylene/polyethylene/polypropylene, or a multilayer thereof, a microporous film, woven fabrics and non-woven fabrics may be used. Moreover, a film made of coating resin having high safety onto a porous polyolefin film may be used.

The electrolyte may include Li salt and a solvent.

As Li salt, one or a mixture of two or more selected from the group consisting of LiPF₆LiBF₄, LiClO₄, LiCl, LiBr, LiI, LiB₁₀Cl₁₀, LiCF₃SO₃, LiCF₃CO₃, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N, (LiFSI), and (CF₃SO₂)₂NLi may be used.

The solvent may include one or more selected from the group consisting of a carbonate-based solvent, an ester-based solvent, an ether-based solvent, or a ketone-based solvent.

### EXAMPLE

Hereinbelow, the present disclosure will be described with reference to an exemplary embodiment of the present disclosure and a comparative example.

First, the main positive electrode material is provided by mixing LiFePO₄ in an amount of 94.0 wt % as the positive electrode active material, a PVDF binder in amount of 2.5 wt % as the binder, and carbon black in an amount of 3.5 wt % as a conductive material. The NCA-based active material is provided as the OCV modifier, and a positive electrode material according to various comparative examples and embodiments is provided while changing whether to contain the OCV modifier and changing a content as shown in Table 1.

TABLE 1

| | Main Positive | | |
|---|---|---|---|
| Classification | Electrode Material | OCV Modifier | |
| Comparative Example 1 | 100 parts by weight | Not contain | |
| Embodiment 1 | 100 parts by weight | 5 | parts by weight |
| Embodiment 2 | 100 parts by weight | 10 | parts by weight |
| Comparative Example 2 | 100 parts by weight | 15 | parts by weight |

Each positive electrode material provided was mixed with NMP to provide a positive electrode slurry which is then coated onto the positive electrode current collector made of an aluminum material, and then hot rolling was performed to obtain a positive electrode.

Graphite in an amount of 95 wt % as the negative electrode active material, carboxy methyl cellulose (CMC) in an amount of 1 wt % and styrene-butadiene rubber (SBR) in an amount of 2 wt % as the binder, and carbon black in an amount of 2 wt % as a conductive material are mixed to provide the negative electrode material. The negative electrode material was mixed with NMP to provide a negative electrode slurry which was then coated onto the negative electrode current collector made of a copper material, and then hot rolling was performed to obtain a negative electrode.

Once the positive electrode and the negative electrode are provided in this way, the electrode loading amount/mixture density was calculated during manufacturing of the positive electrode and the negative electrode, to manufacture individual pole plates which are then stacked in multiple layers, and an electrolyte having added thereto 1:1 EC/DMC and 1M LiPF₆ was injected to perform aging and charging/discharging through a formation process in a proper manner, thereby manufacturing a pouch cell of a capacity of a 1 Ah class.

### Experiment 1: SOC-OCV Evaluation According to Whether to Content OCV Modifier and Content Thereof

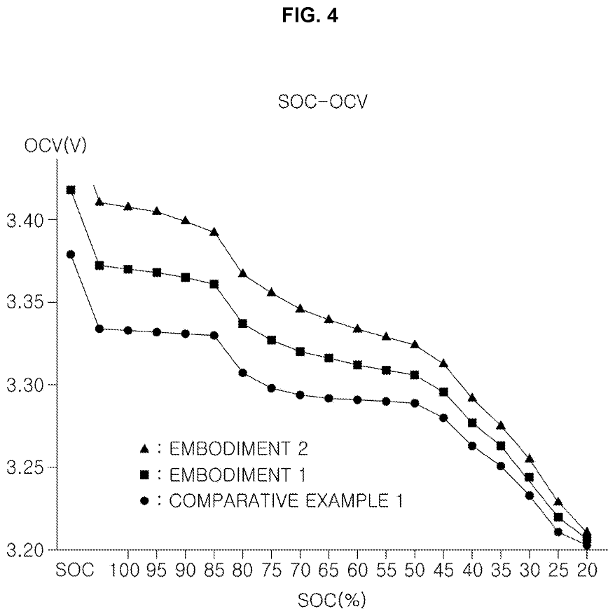

For pouch cells provided according to each comparative example and embodiment, an SOC-OCV is evaluated and a result thereof is shown Tables 2 and 3 below and FIG. 4.

Table 2 shows a value for SOC-OCV (discharge), and Table 3 shows a value for ΔOCV/SOC (mV/%).

In this case, an SOC-OCV evaluation method performs the following evaluation at a room temperature (25° C.).
\textcircled{1} fully charge (0.5C, up to 3.5 V)
\textcircled{2} check OCV after left for 4 hours
\textcircled{3} discharge (0.2C, SOC 5%)
-> repeat \textcircled{2} and \textcircled{3} (until a point in time when SOC 0% is reached)

TABLE 2

| | OCV (V) | | |
|---|---|---|---|
| SOC | Comparative | | |
| (%) | Example 1 | Embodiment 1 | Embodiment 2 |
| 100 | 3.379 | 3.418 | 3.457 |
| 95 | 3.334 | 3.372 | 3.410 |
| 90 | 3.333 | 3.370 | 3.408 |
| 85 | 3.332 | 3.368 | 3.405 |
| 80 | 3.331 | 3.365 | 3.399 |
| 75 | 3.330 | 3.361 | 3.392 |
| 70 | 3.307 | 3.337 | 3.367 |
| 65 | 3.298 | 3.327 | 3.356 |
| 60 | 3.294 | 3.320 | 3.346 |
| 55 | 3.292 | 3.316 | 3.339 |
| 50 | 3.291 | 3.312 | 3.334 |
| 45 | 3.290 | 3.309 | 3.329 |
| 40 | 3.289 | 3.306 | 3.324 |
| 35 | 3.280 | 3.296 | 3.313 |
| 30 | 3.263 | 3.277 | 3.292 |
| 25 | 3.251 | 3.263 | 3.275 |
| 20 | 3.233 | 3.244 | 3.255 |
| 15 | 3.211 | 3.220 | 3.229 |
| 10 | 3.203 | 3.206 | 3.209 |
| 5 | 3.112 | 3.112 | 3.113 |
| 0 | 2.782 | 2.788 | 2.795 |

TABLE 3

| | OCV (V) | | |
|---|---|---|---|
| SOC | Comparative | | |
| (%) | Example 1 | Embodiment 1 | Embodiment 2 |
| 100~95 | 9.00 | 9.20 | 9.38 |
| 95~90 | 0.20 | 0.40 | 0.57 |
| ~85 | 0.20 | 0.40 | 0.52 |
| ~80 | 0.20 | 0.60 | 1.16 |
| ~75 | 0.20 | 0.80 | 1.36 |
| ~70 | 4.60 | 4.80 | 5.01 |
| ~65 | 1.80 | 2.00 | 2.34 |
| ~60 | 0.80 | 1.40 | 1.95 |
| ~55 | 0.40 | 0.80 | 1.36 |
| ~50 | 0.20 | 0.80 | 1.10 |
| ~45 | 0.20 | 0.60 | 1.02 |
| ~40 | 0.20 | 0.60 | 0.90 |
| ~35 | 1.80 | 2.00 | 2.29 |
| ~30 | 3.40 | 3.80 | 4.13 |
| ~25 | 2.40 | 2.80 | 3.30 |
| ~20 | 3.60 | 3.80 | 4.04 |
| ~15 | 4.40 | 4.80 | 5.23 |
| ~10 | 1.60 | 2.80 | 3.94 |
| ~5 | 18.20 | 18.80 | 19.36 |
| ~0 | 66.00 | 64.80 | 63.55 |

As may be seen from Tables 2 and 3 and FIG. 4, for Comparative Example 1 not containing the OCV modifier, an LFP cell SOC was measured in the unit of 1% when a resolution of OCV measurement is within 0.1 mV. Thus, with a sensor applied to a general vehicle, the SOC may not be measured in the unit of 1%.

On the other hand, for Embodiment 1 containing 5 parts by weight and 10 parts by weight of the OCV modifier, the SOC was measured in the unit of 1% when the resolution of OCV measurement was within 0.3 mV, and for Embodiment 2, the SOC was measured in the unit of 1% when the resolution of OCV measurement is within 0.5 mV.

### Experiment 2: Fire Safety Evaluation According to Whether to Content OCV Modifier and Content Thereof

For provided pouch cells according to each comparative example and embodiment, fire safety was evaluated according to the following method and a result thereof is shown in Table 4.

By charging a battery, in an SOC 100% state, fire safety evaluation was performed.
\textcircled{1} Attach a heating plate to a center of a surface of a battery cell. (Heating plate width=¾ of width of battery cell)
\textcircled{2} Attach a temperature sensor to the opposite surface of the battery cell.
\textcircled{3} Heat the battery cell by adjusting the heating plate to 100° C.
\textcircled{4} Turn off the heating plate when the temperature of the temperature sensor attached to the battery cell reaches 80° C.
\textcircled{5} Observe the state of the battery cell by leaving the battery cell for 2 hours. (Check temperature change and ignition)

TABLE 4

| | Comparative | Embodiment | Embodiment | Comparative | Comparative |
|---|---|---|---|---|---|
| Classification | Example 1 | 1 | 2 | Example 2 | Example 3 |
| Combustion | X | X | X | ◯ | X |
| Maximum | 130.2 | 144.5 | 155.0 | ≥500 | ≥500 |
| Temperature | | | | Possible | (Possible |
| Reached | | | | Maximum | Maximum |
| (° C.) | | | | Measurement | Measurement |
| | | | | Value) | Value) |
| Fire Safety | Vehicle | Vehicle | Vehicle | Vehicle | Vehicle |
| | Applicability | Applicability | Applicability | Applicability | Applicability |
| | Applicable | Applicable | Applicable | Inapplicable | Inapplicable |

In a battery combustion process, temperature rise (e.g., 150° C). with heat emission due to decomposition of an electrolyte and secondary electrolyte interfaces (SEI)->heat emission due to decomposition of an electrode material->short-circuit/combustion due to temperature rise occur in that order.

For an LFP secondary battery, due to extremely low heat emission of a positive electrode material, LiFePO₄, in spite of decomposition of the electrolyte/SEI, the temperature did not further rise around 150° C., not leading to combustion.

However, by adding NCA having high heat emission as the OCV modifier, the heat emission increased and the increase of the content thereof led to a combustion stage.

As shown in Table 4, for Embodiment 1 and Embodiment 2 including the OCV modifier to proper contents, the heat emission based on containing of the OCV modifier was limited, thus not leading to the combustion stage, but for Comparative Example 2 including an excessive content of the OCV modifier, the combustion stage occurred.

Although the present disclosure has been described with reference to the accompanying drawings and the above-described preferred embodiments, the present disclosure is not limited thereto, but is defined by the following claims. Accordingly, those of ordinary skill in the art may variously change and modify the present disclosure within the scope without departing from the technical spirit of the claims to be described later.

### DESCRIPTION OF REFERENCE NUMERALS

10: positive electrode
11: positive electrode current collector
12: positive electrode material
13: positive electrode active material
14: conductive material binder
20: negative electrode
21: negative electrode current collector
22: negative electrode material
30: separation film
40: electrolyte
100: positive electrode
110: positive electrode current collector
120: main positive electrode material
121: positive electrode active material
122: conductive material
123: binder
130: OCV modifier

What is claimed is:

1. A positive electrode material composition for a lithium (Li) secondary battery, comprising:
a main positive electrode material comprising a positive electrode active material comprising a lithium ferrum phosphoric acid (LFP) oxide, a conductive material, and a binder; and
an open circuit voltage (OCV) modifier transforming the OCV.

2. The positive electrode material of claim 1, wherein the positive electrode material composition comprises the OCV modifier in an amount of about 3 to 12 parts by weight with respect to 100 parts by weight of the main positive electrode material.

3. The positive electrode material of claim 2, wherein the positive electrode material composition comprises the OCV modifier in an amount of about 5 to 10 parts by weight with respect to 100 parts by weight of the main positive electrode material.

4. The positive electrode material of claim 1, wherein the positive electrode active material comprises LiFePO₄, the conductive material comprises carbon black, and the binder comprises polyvinylidene fluoride (PVDF).

5. The positive electrode material of claim 4, wherein the main positive electrode material comprises the positive electrode active material in an amount of about 88 to 98 wt %, the conductive material in an amount of about 0.5 to 10 wt %, and the binder in an amount of about 0.5 to 5 wt %, the wt % are based on the total weight of the main positive electrode material.

6. The positive electrode material of claim 1, wherein the OCV modifier comprises one or more of a ternary active material, an extended material of ternary active material, a lithium manganese oxide (LMO)-based active material, a metal reacting with lithium (Li) in a potential region of about 2.5 to 3.5 V vs. Li/Li⁺, and a metal oxide reacting with Li in the potential region of about 2.5 to 3.5 V vs. Li/Li⁺.

7. The positive electrode material of claim 6, wherein the ternary active material comprises a nickel-cobalt-manganese (NCM)-based active material or a nickel-cobalt-aluminum (NCA)-based active material,
the extended material of the ternary active material comprises a nickel-cobalt-manganese-aluminum (NCMA)-based active material, the metal reacting with lithium (Li) in the potential region of about 2.5 to 3.5 V vs. Li/Li⁺ comprises ruthenium (Ru) or iridium (Ir), and the metal oxide reacting with lithium (Li) in the potential region of about 2.5 to 3.5 V vs. Li/Li⁺ comprises a manganese oxide, a nickel oxide, a cobalt oxide, a sulfur oxide, a ruthenium oxide or an iridium oxide.

8. A lithium secondary battery comprising:
a positive electrode comprising a positive electrode material coated onto a positive electrode current collector, the positive electrode comprising (i) a main positive electrode material comprising a positive electrode active material formed of a lithium ferrum phosphoric acid (LFP) oxide and (ii) an open circuit voltage (OCV) modifier transforming the OCV;
a negative electrode comprising a negative electrode active material coated onto a negative electrode current collector; and
an electrolyte.

9. The lithium secondary battery of claim 8, wherein the main positive electrode material further comprises a conductive material and a binder.

10. The lithium secondary battery of claim 9, wherein the main positive electrode material comprises the positive electrode active material in an amount of about 88 to 98 wt %, the conductive material in an amount of about 0.5-10 wt %, and the binder in an amount of about 0.5-5 wt %, the wt % are based on the total weight of the main positive electrode material.

11. The lithium secondary battery of claim 9, wherein the positive electrode active material comprises LiFePO₄, the conductive material comprises carbon black, and the binder comprises polyvinylidene fluoride (PVDF).

12. The lithium secondary battery of claim 8, wherein the positive electrode material comprises the OCV modifier in an amount of about 3 to 12 parts by weight with respect to 100 parts by weight of the main positive electrode material.

13. The lithium secondary battery of claim 12, wherein the positive electrode material comprises the OCV modifier in an amount of about 5 to 10 parts by weight with respect to 100 parts by weight of the main positive electrode material.

14. The lithium secondary battery of claim 8, wherein the OCV modifier comprises one or more of a ternary active material, an extended material of ternary active material, a lithium manganese oxide (LMO)-based active material, a metal reacting with lithium (Li) in a potential region of about 2.5 to 3.5 V vs. Li/Li⁺ and a metal oxide reacting with Li in the potential region of about 2.5 to 3.5 V vs. Li/Li⁺.

15. The lithium secondary battery of claim 14, wherein the ternary active material comprises a nickel-cobalt-manganese (NCM)-based active material or a nickel-cobalt-aluminum (NCA)-based active material, the extended material of the ternary active material comprises a nickel-cobalt-manganese-aluminum (NCMA)-based active material, the metal oxide reacting with lithium (Li) in the potential region of about 2.5 to 3.5 V vs. Li/Li⁺ comprises ruthenium (Ru) or iridium (Ir), and the metal oxide reacting with lithium (Li) in the potential region of about 2.5 to 3.5 V vs. Li/Li⁺ comprises a manganese oxide, a nickel oxide, a cobalt oxide, a sulfur oxide, a ruthenium oxide or an iridium oxide.

16. A vehicle comprising a lithium secondary battery of claim 8.
